(19) United States
(12) Patent Application Publication
(10) Pub. No.: US 2008/0018561 A1
(43) Pub. Date: Jan. 24, 2008

(54) DRIVING DEVICE OF PLASMA DISPLAY PANEL AND METHOD OF DRIVING THE SAME

(76) Inventors: Byungsoo Song, Anyang-si (KR); Seung Chan Baek, Seoul (KR); Tae-Ok Ha, Busan (KR); Seonghak Moon, Seoul (KR)

Correspondence Address: BIRCH STEWART KOLASCH & BIRCH, PO BOX 747, FALLS CHURCH, VA, 22040-0747, US

(21) Appl. No.: 11/781,034

(22) Filed: Jul. 20, 2007

(30) Foreign Application Priority Data
Jul. 20, 2006 (KR) 10-2006-0068103

(51) Int. Cl. G09G 3/28

(52) U.S. Cl. 345/60

(57) ABSTRACT

A driving device of a plasma display panel and a method of driving the plasma display panel are disclosed. A method of driving a plasma display panel receiving a video signal and displaying an image on the screen includes performing an inverse-gamma correction process on the video signal, calculating an occupation proportion of a maximum gray level of the video signal in a histogram of the video signal using location information of an object displayed on the screen, calculating a motion proportion of the video signal, and calculating an average picture level (APL) of the video signal.

This application claims the benefit of Korean Patent Application No. 10-2006-0068103 filed in Korea on Jul. 20, 2006, which is incorporated herein by reference for all purposes as if fully set forth herein.

### BACKGROUND

1. Field

This document relates to a driving device of a plasma display panel and a method of driving the plasma display panel.

2. Description of the Related Art

A plasma display panel uses the concept a subfield to form one image frame. In other words, several drawings each having a different light intensity form one image. Various light intensities can be represented through the combination of subfields. Each light intensity is called a level of a gray scale. Assuming that 8 subfields are used, the subfields have weight values of 1, 2, 4, 8, 16, 32, 64, and 128, respectively and the maximum number of gray levels capable of being represented through the combination of the subfields is 256. For instance, if an image with 40-level gray level is to be displayed, two subfields having weight values of 8 and 32 are turned on. Further, if an image with 255-level gray level is to be displayed, all the subfields are turned on.

FIG. 1 illustrates the structure of a subfield during one frame of a related art plasma display panel.

As illustrated in FIG. 1, as the number of subfields increases, the number of representable levels of a gray scale increases. Accordingly, softer image can be obtained. On the other hand, in case that the number of subfields is not many, light intensities of an image cannot be successively expressed. Therefore, it is preferable to use a large number of subfields.

However, because a display device such as a television generally displays 50 or 60 frames per second, the time allotted for one frame is 1/50 or 1/60 second. Therefore, the number of usable subfields for such a short period of time is limited. About 10-20 subfields are generally used depending on a driving method and driving algorithms of the plasma display panel.

In case of using 10 subfields, an image can be displayed through 2¹⁰ gray levels. However, some of the 2¹⁰ gray levels are used in consideration of dynamic false countour noise depending on characteristics of the plasma display panel. In other words, because the combination of subfields causing a strong noise is omitted and the combination of the remaining subfields are used, the number of gray levels capable of being represented through the usable subfield combination is greatly reduced.

As above, in case that an image is displayed using the insufficient number of gray levels, the image quality is not good. To improve the image quality, a half toning technique can be used. For instance, the half toning technique uses a principle in which a portion having a light intensity of 1.5 can be obtained by alternately displaying a portion having a light intensity of 1 and a portion having a light intensity of 2 at a high speed. The principle is called a dithering process. Further, a light intensity that cannot be represented using the half toning technique, for example, a light intensity of 1.54 can be diffused into an adjacent pixel. This is called an error diffusion process.

Accordingly, the insufficient gray-scale representation can be fully compensated using the algorithms. In case of using the dithering process, a 4×4 dither mask having a uniform dither pattern is generally used in an image processing and a light intensity depends on the dither pattern of the dither mask. 4 masks are generally repeated every 4 frames.

FIG. 2 illustrates an average picture level (APL) curve and a power curve of a related art plasma display panel.

As illustrated in FIG. 2, a driving method of the plasma display panel is different from that of a liquid crystal display (LCD) in the use of the concept of an average picture level (APL). The APL is expressed by the following Equation 1. The consumption amount of power can be maintained at a predetermined value by controlling the number of sustain pulses corresponding to each APL. Accordingly, an image luminance increases at a low APL, and thus a contrast ratio can increase.

APL=sum of luminance of each pixel/resolution of picture [Equation 1]

An APL curve used in the plasma display panel can have characteristics illustrated in FIG. 2. A power consumed in a bright image can be limited by increasing the number of sustain pulses at a low APL and reducing the number of sustain pulses at a high APL. However, the above-described method increases the power consumption on the screen of a low APL.

### SUMMARY

Accordingly, an exemplary embodiment provides a driving device of a plasma display panel and a method of driving the plasma display panel capable of reducing consumption power by controlling a power using location information of an object on the screen in addition to histogram information and motion information of a video signal.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In one aspect, a method of driving a plasma display panel receiving a video signal and displaying an image on the screen, the method comprises performing an inverse-gamma correction process on the video signal, calculating an occupation proportion of a maximum gray level of the video signal in a histogram of the video signal using location information of an object displayed on the screen, calculating a motion proportion of the video signal, and calculating an average picture level (APL) of the video signal.

Calculating the occupation proportion of the maximum gray level of the video signal in the histogram of the video signal may comprise providing location information of the object in the histogram with respect to a present pixel of the video signal, providing the location information of the object on the screen of the present pixel, controlling the maximum gray level of the video signal depending on the location information, and combining the maximum gray level of the video signal with the location information of the object in the histogram to obtain the occupation proportion of the maximum gray level of the video signal in the histogram using the combined information.

When the output location information is located in the center of the screen, the maximum gray level of the video signal may be controlled to be high, and when the output location information is far away from the screen, the maximum gray level of the video signal may be controlled to be low.

The maximum gray level of the inverse-gamma corrected video signal may be limited using the occupation proportion of the maximum gray level of the video signal, the motion proportion of the video signal, and the APL of the video signal.

The limited maximum gray level may be controlled using one of the APL of the video signal and the number of subfields.

The method may further comprise performing a half toning process on the video signal.

The method may further comprise performing a subfield mapping process on the video signal.

In another aspect, a driving device of a plasma display panel comprises a plasma display panel that receives a video signal and displays an image on the screen, an inverse-gamma correction unit that performs an inverse-gamma correction process on the video signal, a video signal controller that calculates an occupation proportion of a maximum gray level of the video signal in a histogram of the video signal using location information of an object displayed on the screen, a video motion unit that calculates a motion proportion of the video signal, and an average picture level (APL) unit that calculates an APL of the video signal.

The video signal controller may comprise a histogram detection unit that provides location information of the object in the histogram with respect to a present pixel of the video signal, a location detection unit that provides the location information of the object on the screen of the present pixel, a central object privilege calculation unit that controls the maximum gray level of the video signal depending on the location information output from the location detection unit, and a conversion unit that combines the maximum gray level of the video signal output from the central object privilege calculation unit with the location information of the video signal in the histogram to obtain the occupation proportion of the maximum gray level of the video signal in the histogram using the combined information.

When the output location information is located in the center of the screen, the central object privilege calculation unit may control the maximum gray level of the video signal to be high, and when the output location information is far away from the screen, the central object privilege calculation unit may control the maximum gray level of the video signal to be low.

The driving device of the plasma display panel may further comprise a video signal limitation unit that limits the maximum gray level of the inverse-gamma corrected video signal using the occupation proportion of the maximum gray level of the video signal output from the video signal controller, the motion proportion of the video signal output from the video motion unit, and the APL of the video signal output from the APL unit.

The driving device of the plasma display panel may farther comprise a power controller that controls the maximum gray level limited by the video signal limitation unit using one of the APL of the video signal and the number of subfields.

The driving device of the plasma display panel may further comprise a half toning unit that performs a half toning process on the video signal output from the power controller.

The driving device of the plasma display panel may further comprise a subfield mapping unit that performs a subfield mapping process on the video signal.

In still another aspect, a driving device of a plasma display panel comprises a plasma display panel that receives a video signal and displays an image on the screen, an inverse-gamma correction unit that performs an inverse-gamma correction process on the video signal, a video signal controller that calculates an occupation proportion of a maximum gray level of the video signal in a histogram of the video signal using location information of an object displayed on the screen, a video signal limitation unit that limits the maximum gray level of the inverse-gamma corrected video signal using the occupation proportion of the maximum gray level of the video signal output from the video signal controller, and a power controller that controls the maximum gray level limited by the video signal limitation unit using one of an average picture level (APL) of the video signal and the number of subfields.

It is to be understood that both the foregoing general description and the following detailed description are exemplary and explanatory and are intended to provide further explanation of the invention as claimed.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention. In the drawings:

FIG. 1 illustrates the structure of a subfield during one frame of a related art plasma display panel;

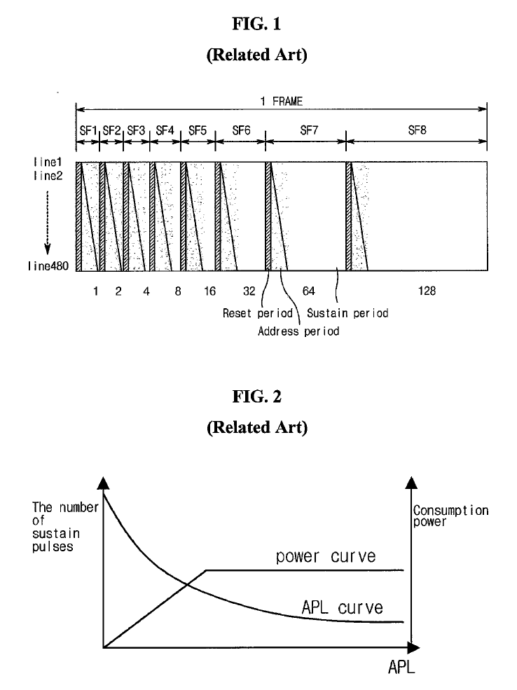

FIG. 2 illustrates an average picture level (APL) curve and a power curve of a related art plasma display panel;

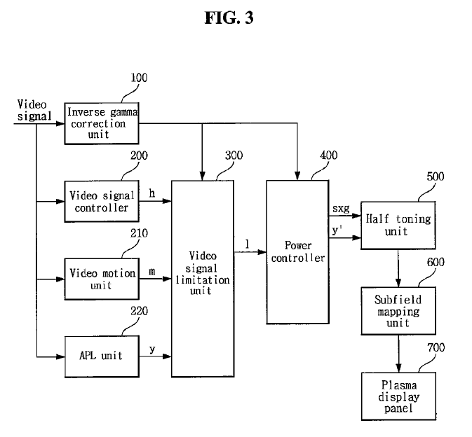

FIG. 3 illustrates a driving device of a plasma display panel according to an exemplary embodiment;

FIG. 4 illustrates a video signal controller of a driving device of a plasma display panel according to an exemplary embodiment;

FIGS. 5a to 5c illustrate histograms of a video signal to which characteristics of each of a video signal controller and a video signal limitation unit according to an exemplary embodiment are applied;

FIGS. 6a and 6b illustrate subfields before and after the application of characteristics of a power controller according to an exemplary embodiment; and

FIGS. 7a and 7b illustrate histograms of a video signal to which characteristics of a video signal limitation unit according to an exemplary embodiment are applied.

### DETAILED DESCRIPTION OF EMBODIMENTS

Reference will now be made in detail embodiments of the invention examples of which are illustrated in the accompanying drawings.

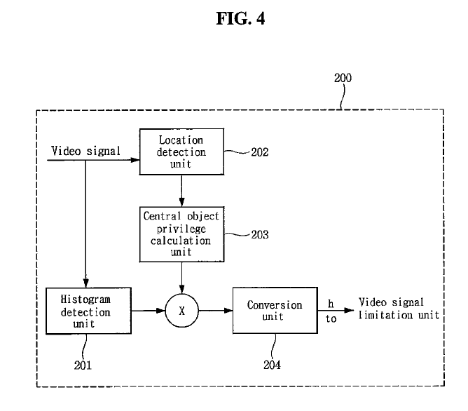

FIG. 3 illustrates a driving device of a plasma display panel according to an exemplary embodiment.

As illustrated in FIG. 3, a driving device of a plasma display panel according to an exemplary embodiment includes an inverse gamma correction unit 100, a video signal controller 200, a video motion unit 210, an average picture level (APL) unit 220, a video signal limitation unit 300, a power controller 400, a half toning unit 500, a subfield mapping unit 600, and a plasma display panel 700.

The inverse gamma correction unit 100 can perform an inverse gamma correction process on a video signal. The inverse gamma correction unit 100 maps an input n-bit video signal according to an inverse gamma curve to convert the n-bit video signal into a Q-bit video signal. Since an input video signal is generally 8 bits, an explanation will be below given of an example of 8-bit video signal. When an 8-bit video signal is corrected into a Q-bit video signal, the inverse gamma correction unit 100 determines an output of the inverse gamma correction depending on the number of sustain pulses.

2^{Q-1}≦P<2^{Q} [Equation 2]

In the above Equation 2, P indicates the number of sustain pulses. For instance, when the number of sustain pulses is 1023, the size of output data is 10 bits through the above Equation 2 and a lookup table (not shown) of the inverse gamma correction unit 100 is determined. In other words, the inverse gamma correction unit 100 outputs an inverse-gamma corrected gray level corresponding to the number of sustain pulses.

The video signal input to the inverse gamma correction unit 100 is a digital signal. In case that an analog video signal is input to the plasma display panel, the analog video signal is converted into a digital video signal using an analog-to-digital converter (not shown). Further, the inverse gamma correction unit 100 may include a lookup table for storing data corresponding to an inverse-gamma curve so as to map a video signal, and a logic circuit for producing logical operations from the data corresponding to the inverse-gamma curve.

Accordingly, the inverse gamma correction unit 100 can output a maximum gray level (S) of the video signal after being inverse gamma corrected.

The video signal controller 200 can calculate an occupation proportion of a maximum gray level of a video signal in a histogram of the video signal using location information of an object displayed on the screen.

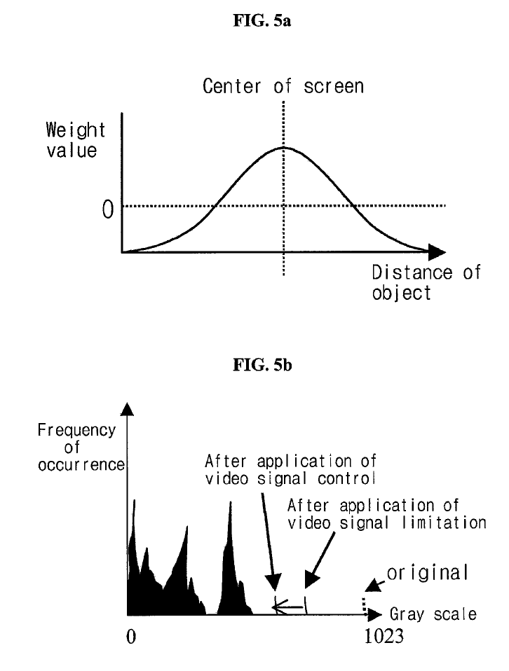

In other words, an occupation proportion (h) of a maximum gray level of a video signal can be output. The maximum gray level of the video signal may be indicated as a white peak. This will be described below with reference to FIG. 4.

The video motion unit 210 can calculate a motion proportion of a video signal displayed on the screen. In other words, a motion proportion (in) of a video signal can be calculated in terms of %.

The APL unit 220 can calculate an APL of a video signal. In other words, an APL (y) of a video signal can be output.

The video signal limitation unit 300 can limit the maximum gray level of the inverse-gamma corrected video signal by the inverse gamma correction unit 100 using the occupation proportion (h) output from the video signal controller 200, the motion proportion (m) output from the video motion unit 210, and the APL (y) output from the APL unit 220.

The video signal limitation unit 300 can output a value (I) obtained by limiting the maximum gray level (S) of the video signal after being inverse-gamma corrected by the inverse gamma correction unit 100 using the above values h, m and y. The value (I) may be inversely proportional to the value (m), and may be proportional to the value (h).

The power controller 400 can control one of an APL of the video signal and the number of subfields using the maximum gray level (S) limited by the video signal limitation unit 300. Therefore, the power controller 400 can change the APL (y) output from the APL unit 220 into an optimized APL (Y′), and can output a value (S*g) obtained by multiplying the maximum gray level (S) of the video signal by a gain (g).

The half toning unit 500 can perform a half toning process on the video signal output from the power controller 400. The half toning unit 500 diffuses a quantization error of digital video data (RGB) after being inverse-gamma corrected into adjacent discharge cells, and then finely controls a luminance of the video signal. For this, the half toning unit 500 divides data into an integer part and a fraction part, and multiplies the fraction part by a previously set error diffusion coefficient (for example, Floid-Steinberg coefficient). Hence, the half toning unit 500 can perform the half toning process on the optimized APL (Y′) and the value (S*g).

The subfield mapping unit 600 can map subfields of the video signal output from the half toning unit 500. The subfield mapping unit 600 maps the digital video data output from the half toning unit 500 according to a subfield pattern previously set based on each bit, and then supplies the mapped data to a data driving integrated circuit (not shown) of the plasma display panel 700 through a data arranging unit (not shown).

The plasma display panel 700 receives the video signal output from the subfield mapping unit 600, and then can display an image on the screen.

As above, the driving device of the plasma display panel according to an exemplary embodiment can compensate a distortion of a video signal using a histogram of the video signal and a weight value depending on a location of a bright portion of an object.

FIG. 4 illustrates a video signal controller of a driving device of a plasma display panel according to an exemplary embodiment.

As illustrated in FIG. 4, the video signal controller 200 includes a histogram detection unit 201, a location detection unit 202, a central object privilege calculation unit 203, and a conversion unit 204.

The histogram detection unit 201 can provide location information of an object in a histogram with respect to a present pixel of a video signal presently input.

The location detection unit 202 can provide location information of the object on the screen with respect to the present pixel. In other words, the location detection unit 202 can calculate a moving distance of the object from the center of the screen.

The central object privilege calculation unit 203 can control a maximum gray level of the video signal depending on the location information output from the location detection unit 202. In other words, when the output location information is located in the center of the screen, a maximum gray level of a video signal is controlled to be high. Further, when the output location information is far away from the center of the screen, a maximum gray level of a video signal is controlled to be low.

The conversion unit 204 combines the maximum gray level of the video signal output from the central object privilege calculation unit 203 with the location information of the object in the histogram, and obtains the occupation proportion (h) of the maximum gray level of the video signal using the combined information.

Accordingly, as the output location information is far away from the center of the screen, the occupation proportion (h) of the maximum gray level of the video signal is reduced. As the output location information is close to the center of the screen, the occupation proportion (b) of the maximum gray level of the video signal increases.

The histogram of the video signal, to which the characteristics of each of the video signal controller 200, the video signal limitation unit 300, and the power controller 400 are applied, will be described below.

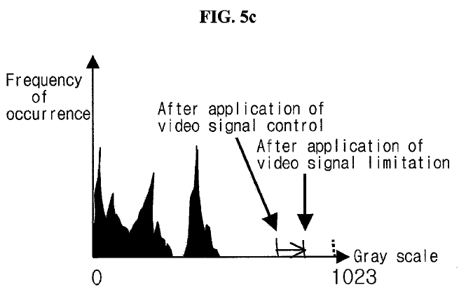

FIGS. 5a to 5c illustrate histograms of a video signal to which characteristics of each of a video signal controller and a video signal limitation unit according to an exemplary embodiment are applied.

FIG. 5a illustrates a histogram of a video signal to which characteristics of the video signal controller 200 are applied. In FIG. 5a, a weight value of the video signal is large in the center of the screen. Further, as the object is far away from the center of the screen, a weight value of the video signal is reduced.

Generally, a main object or a main area of an image is located in the center of the screen, and thus the center of the screen is important. Accordingly, the driving device of the plasma display panel according to an exemplary embodiment supplies information of the video signal obtained through the APL unit and the video motion unit to the video signal limitation unit, and supplies the location information on the object of the video signal obtained through the video signal controller to the video signal limitation unit. Hence, the driving device of the plasma display panel according to an exemplary embodiment can reduce a distortion on the information of the video signal.

The video signal limitation unit can be indicated as maximum input signal control, and the video signal controller can be indicated as central object privilege.

FIGS. 5b and 5c illustrate histograms of a video signal to which characteristics of each of the video signal controller 200 and the video signal limitation unit 300 are applied. In FIGS. 5b and 5c, a transverse axis indicates a gray scale of a video signal, and a longitudinal axis indicates the frequency of occurrence in a gray scale of a video signal.

In FIG. 5b, when the maximum gray level is located outside the screen, a weight value of an input video signal applied by the video signal controller is set to be low and then the video signal limitation unit further reduces the reduced maximum gray level.

In FIG. 5c, when the maximum gray level is located in the center of the screen, although the maximum gray level is low by the application of the characteristics of the video signal limitation unit, a weight value applied by the video signal controller is set to be high. Accordingly, a distortion of the information on the video signal can be compensated.

In other words, the occupation proportion of the maximum gray level of the video signal in the histogram of the video signal is calculated and controlled using the location information of the object displayed on the screen, and thus the power consumption can be reduced and the gray scale representation can be improved.

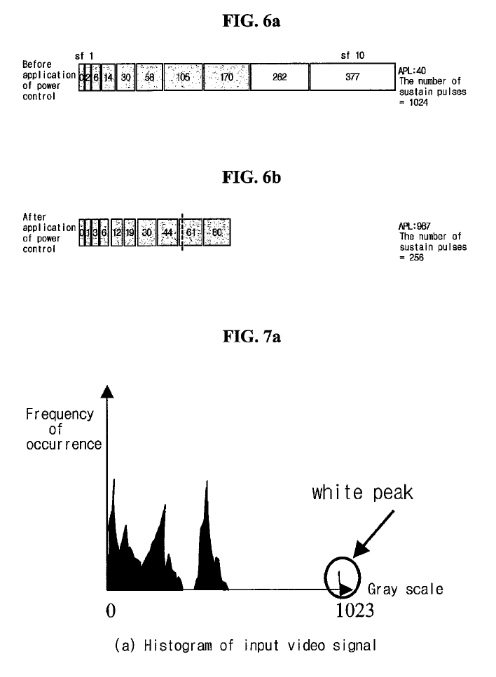

FIGS. 6a and 6b illustrate subfields before and after the application of characteristics of a power controller according to an exemplary embodiment.

FIG. 6a illustrates subfields before the application of characteristics of the power controller. In FIG. 6a, the number of subfields used to display an image at a low APL of 40 is 8. FIG. 6b illustrates subfields after the application of characteristics of the power controller. In FIG. 6b, the number of subfields used to display an image at a low APL of 40 is 10. In other words, assuming that a maximum gray level of a video signal ranges from 1 to 255 (when a gray scale ranges from 1-level gray scale to 1023-level gray scale and the video signal is 10-bit data), an APL is 40, and the total number of sustain pulses is 1024, an input image display ratio is 255/1024 (□¼).

Accordingly, an image can be displayed only using 256 sustain pulses (i.e., (the total number of sustain pulses)/4 (1024/4=256). In case that the total number of sustain pulses is 256, the APL is 987. When the APL is 987, a maximum gray level of the video signal ranges 1 to 1020 using the reciprocal (=4) of the calculated input image display ratio (¼) as a gain value of the video signal. Hence, a half toning noise and power consumption can be reduced.

In other words, the power controller is used to reduce power consumption in the screen of a low APL. The power controller reduces the number of sustain pulses in subfields, which are not actually used, or removes the subfields, which are not actually used to increase the driving efficiency. The power controller according to an exemplary embodiment may be indicated as black power recovery.

The power controller controls the APL and the use of the subfields with reference to the maximum gray level of the video signal. When the maximum gray level is low at a low APL, the use of the power controller is effective. In the other hand, when the maximum gray level is high at a low APL, the use of the power controller is not effective. Since many audiovisual (AV) images pass through a VSC board and perform operations for increasing a contrast ratio such as histogram extension, it is difficult to expect the use effect of the power controller in an actual AV image.

Accordingly, the video signal limitation unit is used to maximize the use effect of the power controller. The video signal limitation unit controls a maximum gray level of the input video signal by changing the input video signal using information of the input video signal.

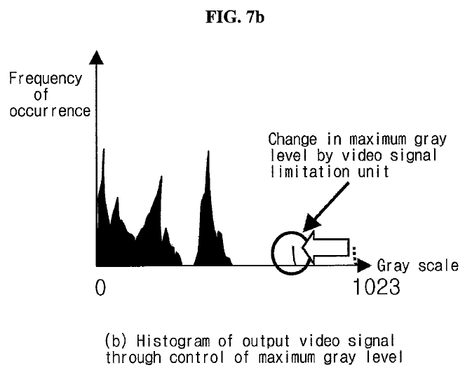

FIGS. 7a and 7b illustrate histograms of a video signal to which characteristics of a video signal limitation unit according to an exemplary embodiment are applied.

FIG. 7a illustrates information on a histogram of a video signal. FIG. 7a illustrates a dark image at a low APL. Most of the video signal has a low gray level, and only a portion of the video signal has a value close to a maximum gray level. This is called a white peak. For instance, the white peak is mainly expressed in the form of a caption, a lamp of the night, or stars of a night sky in an image.

In case that only the power controller is applied to a video signal in which a white peak is generated, the video signal can have a maximum luminance capable of representing a maximum gray level of the video signal in spite of the video signal mainly using a low gray level at a low APL. Therefore, it is difficult to expect the use effect of the power controller.

Accordingly, the video signal limitation unit is used to overcome drawbacks of the power controller. The video signal limitation unit can limit a luminance of a portion of an image having a maximum gray level at a low value using a maximum input signal control method assuming that an occupation proportion of a white peak portion to the entire image is small and negligible.

As illustrated in FIG. 7b, the power consumption caused by the use of the power controller can be reduced by limiting the maximum gray level of the video signal at a low value. Accordingly, the video signal limitation unit determines the strength extent of its performance using the histogram and motion of the video signal.

Further, as illustrated in FIG. 5, the occupation proportion of the maximum gray level is calculated and controlled using location information of an object displayed on the screen in the histogram of the video signal, and thus the power consumption can be reduced and the gray scale representation can be improved.

Accordingly, since an exemplary embodiment sets a gray scale and a luminance using a histogram and a motion of a video signal and location information of an object, a gray scale can be finely represented and the power consumption can be reduced.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A method of driving a plasma display panel receiving a video signal and displaying an image on the screen, the method comprising:
performing an inverse-gamma correction process on the video signal;
calculating an occupation proportion of a maximum gray level of the video signal in a histogram of the video signal using location information of an object displayed on the screen;
calculating a motion proportion of the video signal; and
calculating an average picture level (APL) of the video signal.

2. The method of claim 1, wherein calculating the occupation proportion of the maximum gray level of the video signal in the histogram of the video signal comprises:
providing location information of the object in the histogram with respect to a present pixel of the video signal;
providing the location information of the object on the screen of the present pixel;
controlling the maximum gray level of the video signal depending on the location information; and
combining the maximum gray level of the video signal with the location information of the object in the histogram to obtain the occupation proportion of the maximum gray level of the video signal in the histogram using the combined information.

3. The method of claim 2, wherein when the output location information is located in the center of the screen, the maximum gray level of the video signal is controlled to be high, and
when the output location information is far away from the screen, the maximum gray level of the video signal is controlled to be low.

4. The method of claim 1, wherein the maximum gray level of the inverse-gamma corrected video signal is limited using the occupation proportion of the maximum gray level of the video signal, the motion proportion of the video signal, and the APL of the video signal.

5. The method of claim 4, wherein the limited maximum gray level is controlled using one of the APL of the video signal and the number of subfields.

6. The method of claim 5, further comprising performing a half toning process on the video signal.

7. The method of claim 6, further comprising performing a subfield mapping process on the video signal.

8. A driving device of a plasma display panel comprising:
a plasma display panel that receives a video signal and displays an image on the screen:
an inverse-gamma correction unit that performs an inverse-gamma correction process on the video signal;
a video signal controller that calculates an occupation proportion of a maximum gray level of the video signal in a histogram of the video signal using location information of an object displayed on the screen;
a video motion unit that calculates a motion proportion of the video signal; and
an average picture level (APL) unit that calculates an APL of the video signal.

9. The driving device of the plasma display panel of claim 8, wherein the video signal controller comprises:
a histogram detection unit that provides location information of the object in the histogram with respect to a present pixel of the video signal;
a location detection unit that provides the location information of the object on the screen of the present pixel;
a central object privilege calculation unit that controls the maximum gray level of the video signal depending on the location information output from the location detection unit; and
a conversion unit that combines the maximum gray level of the video signal output from the central object privilege calculation unit with the location information of the video signal in the histogram to obtain the occupation proportion of the maximum gray level of the video signal in the histogram using the combined information.

10. The driving device of the plasma display panel of claim 9, wherein when the output location information is located in the center of the screen, the central object privilege calculation unit controls the maximum gray level of the video signal to be high, and when the output location information is far away from the screen, the central object privilege calculation unit controls the maximum gray level of the video signal to be low.

11. The driving device of the plasma display panel of claim 8, further comprising a video signal limitation unit that limits the maximum gray level of the inverse-gamma corrected video signal using the occupation proportion of the maximum gray level of the video signal output from the video signal controller, the motion proportion of the video signal output from the video motion unit, and the APL of the video signal output from the APL unit.

12. The driving device of the plasma display panel of claim 11, further comprising a power controller that controls the maximum gray level limited by the video signal limitation unit using one of the APL of the video signal and the number of subfields.

13. The driving device of the plasma display panel of claim 12, further comprising a half toning unit that performs a half toning process on the video signal output from the power controller.

14. The driving device of the plasma display panel of claim 13, further comprising a subfield mapping unit that performs a subfield mapping process on the video signal.

15. A driving device of a plasma display panel comprising:
a plasma display panel that receives a video signal and displays an image on the screen:
an inverse-gamma correction unit that performs an inverse-gamma correction process on the video signal;
a video signal controller that calculates an occupation proportion of a maximum gray level of the video signal in a histogram of the video signal using location information of an object displayed on the screen;
a video signal limitation unit that limits the maximum gray level of the inverse-gamma corrected video signal using the occupation proportion of the maximum gray level of the video signal output from the video signal controller; and
a power controller that controls the maximum gray level limited by the video signal limitation unit using one of an average picture level (APL) of the video signal and the number of subfields.

16. The driving device of the plasma display panel of claim 15, wherein the video signal controller comprises:
a histogram detection unit that provides location information of the object in the histogram with respect to a present pixel of the video signal;
a location detection unit that provides the location information of the object on the screen of the present pixel;
a central object privilege calculation unit that controls the maximum gray level of the video signal depending on the location information output from the location detection unit; and
a conversion unit that combines the maximum gray level of the video signal output from the central object privilege calculation unit with the location information in the histogram to obtain the occupation proportion of the maximum gray level of the video signal in the histogram using the combined information.

17. The driving device of the plasma display panel of claim 16, wherein when the output location information is located in the center of the screen, the central object privilege calculation unit controls the maximum gray level of the video signal to be high, and
when the output location information is far away from the screen, the central object privilege calculation unit controls the maximum gray level of the video signal to be low.

18. The driving device of the plasma display panel of claim 15, further comprising a video motion unit that calculates a motion proportion of the video signal, and an APL unit that calculates an APL of the video signal.

19. The driving device of the plasma display panel of claim 18, further comprising a half toning unit that performs a half toning process on the video signal output from the power controller.

20. The driving device of the plasma display panel of claim 19, further comprising a subfield mapping unit that performs a subfield mapping process on the video signal.
